(19) United States
(12) Patent Application Publication
(10) Pub. No.: US 2016/0277269 A1
(43) Pub. Date: Sep. 22, 2016

(54) DYNAMIC COMMUNITY SUPPORT

(71) Applicant: International Business Machines Corporation, Armonk, NY (US)

(72) Inventors: Al Chakra, Apex, NC (US); Christopher J. Dawson, Arlington, VA (US); Yu Deng, Yorktown Heights, NY (US); Rick A. Hamilton, II, Charlottesville, VA (US); Jenny S. Li, Danbury, CT (US); Liangzhao Zeng, Sunnyvale, CA (US)

(21) Appl. No.: 14/662,479

(22) Filed: Mar. 19, 2015

(51) Int. Cl. H04L 12/26; H04L 12/24

(52) U.S. Cl. CPC H04L 43/0823; H04L 41/0853

(57) ABSTRACT

An approach for assisting a user with a service request is provided. In the approach, it is determined that an error has occurred on a computing device of a user. A processor identifies information about the computing device. A processor determines that the computing device corresponds to a group of one or more additional computing devices, within a predetermined threshold, based on at least, on the information about the computing device. A processor causes the user to enter into a communication with at least a second user of a second computing device, wherein the second computing device is one of the group of one or more additional computing devices.

### TECHNICAL FIELD

The present invention relates generally to the field peer to peer support for users in a cloud environment, more particular to matching peers with similar system setups and components.

### BACKGROUND

Cloud computing is computing in which large groups of remote servers are networked to allow centralized data storage and online access to computer services or resources. Cloud networks can be classified as public, private, or a hybrid of the two. Cloud services within the cloud services made available to users on demand via the Internet from a cloud computing provider's servers as opposed to being provided from an end user's personal servers. Cloud services are designed to provide easy, scalable access to applications, resources, and servers, and are fully managed by a cloud service provider. A cloud service provider can fluctuate in size based on the needs of its users and the resources of the cloud service provider.

Customer service is the provision of service to customers before, during, and after a purchase. Customer service is a series of activities designed to enhance the level of customer satisfaction with the purchased goods. The type of service offered varies greatly by product, industry, or service to the customer. The customer service is designed to assist the customer in the correct use of a product in the most cost effective manner. This assistance is through service representatives or automated means. The assistance provided by the service representatives can be performed by chat windows though the Internet, phone conversations, or in person meetings. Automated means of customer service can be in the form of an automated online assistance, or self-service (through tutorials presented to the customer). A recent addition to the customer service industry is the use of blogs, or chatrooms, to receive support from third parties that have knowledge on the customer's issue.

Cloud computing service providers offer numerous value-add services to ensure that infrastructures are meeting customer expectations. However, additional services may be offered to capitalize on the unique perspective which cloud environments have. If a user of a program is having an issue with the program, the service provider does not provide application level support. In legacy behavior, the user searches the Internet for hints as to how to fix the issue, or the user may search global customer forums. The forums and the Internet are broad and it can be difficult for a user to locate a solution to the specific problem the user is experiencing. Even if the user is able to locate a solution, the solution may be for a different computing environment, application level, or operating system.

Some documents address the concern of connecting the user having an issue with a customer service representative who would be able to assist the user. Harris et al. (U.S. Pat. No. 8,719,706 B2) states that “a cloud help system that is a confederation of both internet and product help content that gives the user of a software application a rich web-based user interface for searching the internet in conjunction with and in the context of the software application. An application developer associates identifiers with various features and areas within an application. Upon detecting a user request for product help, the system receives the identifier and identifies instructional material related to the received identifier. The instructional material combines traditional local and online help information with dynamic content from an online data source. The online data source includes an association between each identifier and one or more searches for online content.” (Harris, Abstract) Specifically, “[i]n some embodiments, the cloud help system provides automatic help information as a user navigates through a software application. Instead of waiting for the user to select a context menu option or invoke help through a keystroke (e.g., F1), the system may receive indications from the software application as the user selects menu items, controls, or other user interface features. This allows the system to automatically update a help pane or other window of help content so that the user can view helpful information alongside the application that is constantly relevant based on what the user is currently doing in the application.” (Harris, Col. 11, Lines 61-67)

An administrator can update the online searches over time so that new material can be incorporated. Yeh et al. (US Patent Pub. No. 2014/0245141 A1) states that “contextual user assistance for cloud services, an assistance panel is presented as part of the cloud service portal and is available in the user interface of the portal. The assistance panel can provide contextual assistance based on current user information, including task or error messages, as well as product name and user role. The assistance panel provides assistance functions including a search function, a browse syndicated community content function, and a post to a community forum function within the cloud service portal and can transform to accommodate the functions. For the browse function, the assistance panel uses the current user information to dynamically update a list of syndicated community content that can potentially match the user's needs as the user navigates to different pages presented in the portal. A content curator tool can be used to control and prioritize the content surfaced by the browse function.” (Yeh, Abstract) Specifically, “[t]he assistance panel uses the current user information to dynamically update a list of syndicated Help content that can potentially match the user's needs as the user navigates to different pages presented in the portal. The Help content can be obtained from various sources including websites, a Support knowledge base, community forums, and product support resources. A search field can also be provided to enable users to search Help content by keywords and receive curated content further scoped by the user's product, role and current task. The assistance panel also provides a gateway for users to compose a question from the portal, submit the question directly to a community forum, and receive a notification when the question is answered—without leaving the portal.” (Yeh, [0005])

### SUMMARY

In one aspect, the present invention provides a method for assisting a user with a service request. The method includes determining that an error has occurred on a first computing device of a first user. The method further identifying information about the first computing device. The method further includes determining that the first computing device corresponds to a group of one or more additional computing devices, within a predetermined threshold, based, at least, on the information about the first computing device. The method further includes causing the first user to enter into a communication with at least a second user of a second computing device, wherein the second computing device is of the group of one or more additional computing devices.

In another aspect, the present invention provides a computer program product for assisting a user with a service request. The computer program product includes one or more computer readable storage media and program instructions stored on the one or more computer readable storage media. The program instructions include program instructions to determine that an error has occurred on a first computing device of a first user. The program instructions further include program instructions to identify information about the first computing device. The program instructions further include program instructions to determine that the first computing device corresponds to a group of one or more additional computing devices, within a predetermined threshold, based, at least, on the information about the first computing device. The program instructions further include program instructions to cause the first user to enter into a communication with at least a second user of a second computing device, wherein the second computing device is of the group of one or more additional computing devices.

In yet another aspect, the present invention provides a computer system for assisting a user with a service request. The computer system includes one or more computer processors, one or more computer readable storage media, and program instructions stored on the computer readable storage media for execution by at least one of the one or more processors. The program instructions include program instructions to determine that an error has occurred on a first computing device of a first user. The program instructions further include program instructions to identify information about the first computing device. The program instructions further include program instructions to determine that the first computing device corresponds to a group of one or more additional computing devices, within a predetermined threshold, based, at least, on the information about the first computing device. The program instructions further include program instructions to cause the first user to enter into a communication with at least a second user of a second computing device, wherein the second computing device is of the group of one or more additional computing devices.

In yet another aspect, the present invention provides a method for assisting a user with a service request, comprising: providing a computer infrastructure being operable to: determine that an error has occurred on a first computing device of a first user; identify information about the first computing device; determine that the first computing device corresponds to a group of one or more additional computing devices, within a predetermined threshold, based, at least, on the information about the first computing device; cause the first user to enter into a communication with at least a second user of a second computing device, wherein the second computing device is of the group of one or more additional computing devices.

### BRIEF DESCRIPTION OF THE DRAWINGS

FIG. 1 is a block diagram of a cloud computing node according to an embodiment of the present invention.

FIG. 2 is a block diagram of a cloud computing environment according to an embodiment of the present invention.

FIG. 3 is a depiction of an abstraction model layers according to an embodiment of the present invention.

FIG. 4 depicts a block diagram of a computing environment, in accordance with one embodiment of the present invention.

FIG. 5 depicts a flowchart depicting operational steps of relevancy function executing within the computing system of FIG. 4, in accordance with one embodiment of the present invention.

FIG. 6 depicts a flowchart depicting operational steps of a method to track a client's actions and offer assistance to the user, in accordance with one embodiment of the present invention.

FIG. 7 depicts a flowchart depicting operational steps of a method to create and populate a group which can assist a user, in accordance with one embodiment of the present invention.

### DETAILED DESCRIPTION

Embodiments of the present invention recognize that customer services do not always fully utilize the cloud computing environment. While some documents highlight the value of community software development and support, these documents may lack teaching communication between users and the intelligence of detecting if support is required. Cloud computing provides many services to users but may not personalize customer service to the user. Customer service within a cloud environment may not capitalize on stored data that includes application execution history, user records, virtual machine configuration, or other aspects of user's activity within the cloud environment. This data can be mined and analyzed to direct a user to a customer service or community that can provide more specific and accurate assistance to the user.

Embodiments of the present invention disclose an approach to provide a process to use stored data of users computing devices to direct the users to a more efficient and effective customer service.

The present invention will now be described in detail with reference to the Figures.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

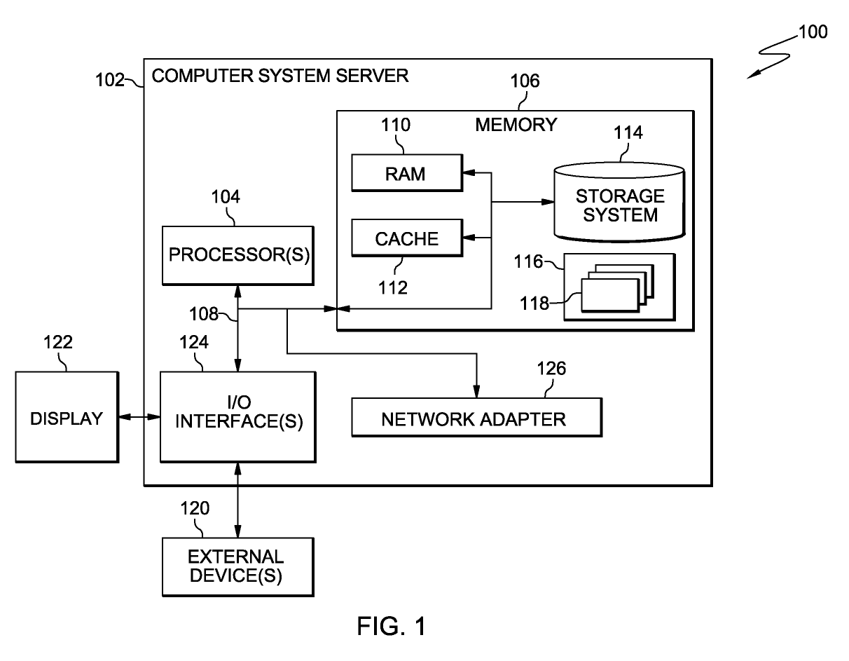

FIG. 1, a schematic of an example of a cloud computing node is shown. Cloud computing node 100 is only one example of a suitable cloud computing node and is not intended to suggest any limitation as to the scope of use or functionality of embodiments of the invention described herein. Regardless, cloud computing node 100 is capable of being implemented and/or performing any of the functionality set forth hereinabove.

In cloud computing node 100 there is a computer system server 102, which is operational with numerous other general purpose or special purpose computing system environments or configurations. Examples of well-known computing systems, environments, and/or configurations that may be suitable for use with computer system server 102 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system server 102 may be described in the general context of computer system executable instructions, such as program modules, being executed by a computer system. Generally, program modules may include routines, programs, objects, components, logic, data structures, and so on that perform particular tasks or implement particular abstract data types. Computer system server 102 may be practiced in distributed cloud computing environments where tasks are performed by remote processing devices that are linked through a communications network. In a distributed cloud computing environment, program modules may be located in both local and remote computer system storage media including memory storage devices.

FIG. 1, computer system server 102 in cloud computing node 100 is shown in the form of a general-purpose computing device. The components of computer system server 102 may include, but are not limited to, one or more processors or processing units 102, a system memory 106, and a bus 108 that couples various system components including system memory 106 to processor(s) 104.

Bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system server 102 typically includes a variety of computer system readable media. Such media may be any available media that is accessible by computer system server 102, and it includes both volatile and non-volatile media, removable and non-removable media.

System memory 106 can include computer system readable media in the form of volatile memory, such as random access memory (RAM) 110 and/or cache memory 112. Computer system server 102 may further include other removable/non-removable, volatile/non-volatile computer system storage media. By way of example only, storage system 114 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 108 by one or more data media interfaces. As will be further depicted and described below, memory 106 may include at least one program product having a set (e.g., at least one) of program modules that are configured to carry out the functions of embodiments of the invention.

Program/utility 116, having a set (at least one) of program modules 118, may be stored in memory 106 by way of example, and not limitation, as well as an operating system, one or more application programs, other program modules, and program data. Each of the operating system, one or more application programs, other program modules, and program data, or some combination thereof, may include an implementation of a networking environment. Program modules 118 generally carry out the functions and/or methodologies of embodiments of the invention as described herein.

Computer system server 102 may also communicate with one or more external devices 120 such as a keyboard, a pointing device, a display 122, etc.; one or more devices that enable a user to interact with computer system server 102; and/or any devices (e.g., network card, modem, etc.) that enable computer system server 102 to communicate with one or more other computing devices. Such communication can occur via Input/Output (I/O) interfaces 124. Still yet, computer system server 102 can communicate with one or more networks such as a local area network (LAN), a general wide area network (WAN), and/or a public network (e.g., the Internet) via network adapter 126. As depicted, network adapter 126 communicates with the other components of computer system server 102 via bus 108. It should be understood that although not shown, other hardware and/or software components could be used in conjunction with computer system server 102. Examples, include, but are not limited to: microcode, device drivers, redundant processing units, external disk drive arrays, RAID systems, tape drives, and data archival storage systems.

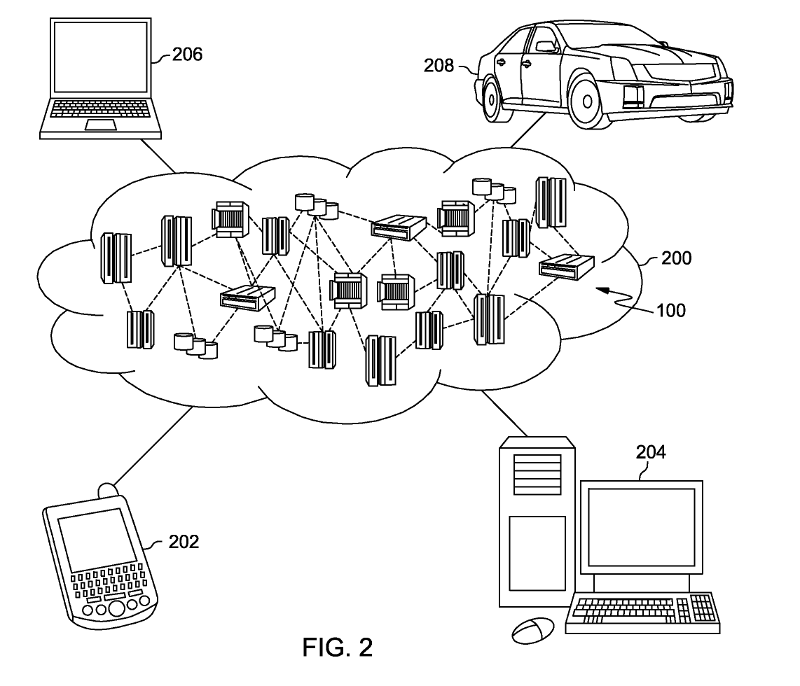

FIG. 2, illustrative cloud computing environment 200 is depicted. As shown, cloud computing environment 200 includes one or more cloud computing nodes 100 with which local computing devices used by cloud consumers, such as, for example, personal digital assistant (PDA) or cellular telephone 202, desktop computer 204, laptop computer 206, and/or automobile computer system 208 may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 200 to offer infrastructure, platforms and/or software as services for which a cloud consumer does not need to maintain resources on a local computing device. It is understood that the types of computing devices 202 shown in FIG. 2 are intended to be illustrative only and that computing nodes 100 and cloud computing environment 200 can communicate with any type of computerized device over any type of network and/or network addressable connection (e.g., using a web browser).

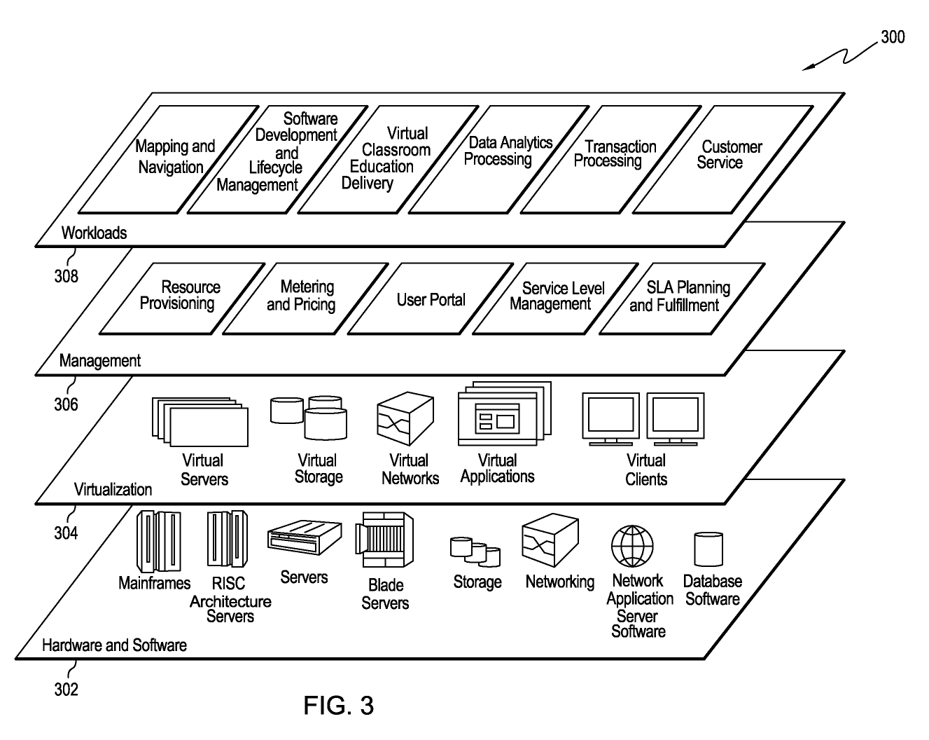

FIG. 3, depicts a set of functional abstraction layers provided by cloud computing environment 300 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 302 includes hardware and software components. Examples of hardware components include: mainframes; RISC (Reduced Instruction Set Computer) architecture based servers; storage devices; networks and networking components. In some embodiments, software components include network application server software.

Virtualization layer 304 provides an abstraction layer from which the following examples of virtual entities may be provided: virtual servers; virtual storage; virtual networks, including virtual private networks; virtual applications and operating systems; and virtual clients.

In one example, management layer 306 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of the resources. In one example, the resources may include application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, procurement of, cloud computing resources for which a future requirement is anticipated in accordance with an SLA.

Workloads layer 308 provides examples of functionality for which the cloud computing environment may be utilized. Examples of workloads and functions which may be provided from this layer include: mapping and navigation; software development and lifecycle management; virtual classroom education delivery; data analytics processing; transaction processing; and a customer service method utilizing community support.

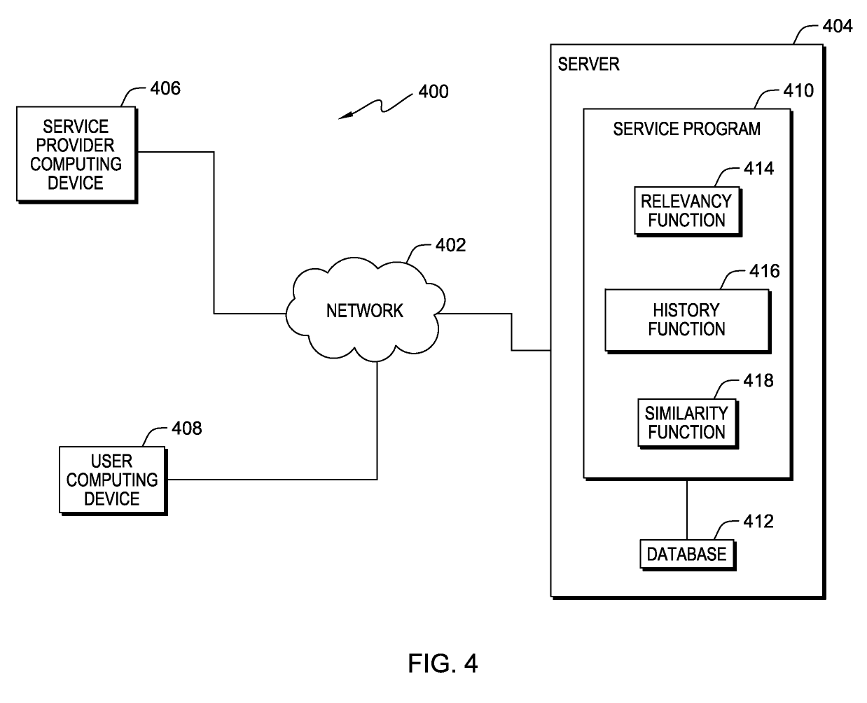

FIG. 4 depicts a block diagram of a computing environment 400 in accordance with one embodiment of the present invention. FIG. 4 provides an illustration of one embodiment and does not imply any limitations regarding to the environment in which different embodiments maybe implemented. In the depicted embodiment, computing environment 400 includes network 402, server 404, service provider computing device 406, and user computing device 408. As depicted, computing environment 400 provides an environment for service program 410 to access user computing device 408 through network 402. Computing environment 400 may include additional servers, computers, or other devices not shown.

Network 402 may be a local area network (LAN), a wide area network (WAN) such as the Internet, any combination thereof, or any combination of connections and protocols which support communications between server 404, service provider computing device 406 and user computing device 408, in accordance with embodiments of the invention. Network 402 may include wired, wireless, or fiber optic connections.

Server 404 may be a management server, a web server, or any other electronic device or computing system capable of processing program instructions and receiving and sending data. In some embodiments, server 404 may be a laptop computer, tablet computer, netbook computer, personal computer (PC), a desktop computer, or any programmable electronic device capable of communicating with service provider computing device 406, and user computing device 408 via network 402. In other embodiments, server 404 may represent a server computing system utilizing multiple computers as a server system, such as in a cloud computing environment. In another embodiment, server 404 represents a computing system utilizing clustered computers and components to act as a single pool of seamless resources. In the depicted embodiment, server 404 includes service program 410, relevancy function 214, history function 216, similarity function 218, and database 412. Server 404 may include components, as depicted and described in further detail with respect to FIG. 1.

Service provider computing device 406 may be a desktop computer, laptop computer, tablet computer, netbook computer, personal computer (PC), a desktop computer, mobile device, or any programmable electronic device capable of communicating via network 402. In other embodiments, user computing device 408 may be any electronic device or computing system capable of sending and receiving data, and communicating with user computing device 408, and server 404 via network 102. Service provider computing device 406 is managed by service provider. The service provider can be, but is not limited, to a telecommunication service provider (TSP), application service provider (ASP), storage service provider (SSP), Internet service providers (ISP), and/or other service provider. In the depicted embodiment, user computing device 408 communicates with user computing device 408 and server 404 via network 402.

User computing device 408 may be a desktop computer, laptop computer, tablet computer, netbook computer, personal computer (PC), a desktop computer, mobile device, or any programmable electronic device capable of communicating via network 402. In other embodiments, user computing device 408 may be any electronic device or computing system capable of sending and receiving data, and communicating with service provider computing device 406, and server 404 via network 102. In the depicted embodiment, user computing device 408 communicates with service provider computing device 406 and server 404 via network 402.

Database 412 may be a repository which may be written to and/or read by service program 410, relevancy function 414, history function 416, and similarity function 418. Information gathered from service program 410, relevancy function 414, history function 416, and/or similarity function 418 may be stored to database 412. Examples of the information that can be stored are but not limited to, user computing device 408 hardware and software, user computing devices hardware and software, group member lists, and other information that is relevant to service program 410, relevancy function 414, history function 416, and/or similarity function 418. In one embodiment, database 412 is a database management system (DBM) used to allow the definition, creation, querying, update, and administration of a database(s). In the depicted embodiments, database 412 resides on server 404. In other embodiments, database 412 reside on another server, or another computing device, provided that database 412 is accessible to service program 410, user computing device 408 and service provider computing device 406.

Service program 410 operates to perform an analysis of user computing device 408 and connect the client with other users which are able to provide assistance. In the depicted embodiment, service program 410 utilizes network 402 to access user computing device 408. Service program 410 includes relevancy function 414, history function 416, and similarity function 418. In the depicted embodiment, service program 410 resides on server 404. In other embodiments, service program 410 may be located on another server or computing device, provided service program 410 has access to service provider computing device 406, user computing device 408, and database 412.

Relevancy function 414 operates to analyze environmental parameters of user computing device 408 and provide information to service provider computing device 406 to locate a customer service representative who has knowledge on the specifics of user computing device 408 or another user who has a similar computing device setup as user computing device 408. Environmental parameters may include, for example user computing device 408 hardware setup or user computing device 408 software setup. The hardware setup may include, for example motherboard, central processing unit (CPU), random access memory (RAM), hard drive, optical drive, or other components that are used to build a computing unit. The software setup may include, for example, applications, versions, operating systems, application functionality, and firmware versions. In one embodiment, relevancy function 414 records a mixture of firmware, hardware, and software components of user computing device 408. In one embodiment, the information relevancy function 414 gathers is stored in database 412. In the depicted embodiment, relevancy function 414 is located on server 404. In one embodiment, relevancy function 414 may be located on other servers, or computing devices, provided relevancy function 414 have access to service provider computing device 406, user computing device 408, and database 412.

History function 416 operates to gather a group of other users, service representatives, or other forms of customer support to assist the client, after the client has performed actions without the intended result. When a client requests assistance, service provider computing device 406 locates a group of service representatives or other users that are knowledgeable on the client's request. In one embodiment, history function 416 monitors the client's actions. If history function 416 determines the client repeatedly performing the same task or procedure, the client performs a task for an extended period of time, or the client performs generalized web searches on help topics related to the task or procedure the client is attempting to accomplish. History function 416 communicates this information to the service provider. In another embodiment, history function 416 monitors the client's actions; however, history function 416 stores the information in database 412 until the client contacts the service provider requesting assistance. It is not until service provider computing device 406 communicates with history function 416 that the information is released from database 412. In other embodiments, the information history function 416 gathers is stored in another storage location accessible by service provider computing device 406. In the depicted embodiment, history function 416 is located on server 404. In one embodiment, history function 416 may be located on other servers, or computing devices, provided history function 416 have access to service provider computing device 406, user computing device 408, and database 412.

Similarity function 418 operates to gather a group of other users, service representatives, or other forms of customer support for the client after the client has created a support group or a point to point request for assistance. Once the group or point to point request for assistance is created, similarity function 418 determines the current setup of user computing device 408. Once similarity function 418 access the information regarding user computing device 408 hardware or software setup, similarity function 418 locates other users, service representatives, or other forms of customer support who have similar setups as the client and connects the client and the assistance. In one embodiment, similarity function 418 monitors and updates group members' hardware and/or software setup. As group members' software and/or hardware is modified from the software and hardware setup of user computing device 408, or other computing devices of the group, similarity function 418 updates the group members to keep only the group members with the most similar computing device setup as user computing device 408. In one embodiment, similarity function 418 uses client's support group if a second client creates a group with a similar setup for a similar problem and similarity function 418 merges the two groups together. In one embodiment, where the client requests peer to peer requests, similarity function 418 determines the hardware and/or software of user computing device 408, and similarity function 418 finds a single user with a similar setup and connects the client and the user. In one embodiment, the information similarity function 118 gathers is stored in database 412. In other embodiments, the information similarity function 118 gathers is stored in another storage location accessible by service provider computing device 406. In the depicted embodiment, similarity function 418 is located on server 404. In one embodiment, similarity function 418 may be located on other servers or computing devices, provided similarity function 418 have access to service provider computing device 406, user computing device 408, and database 412.

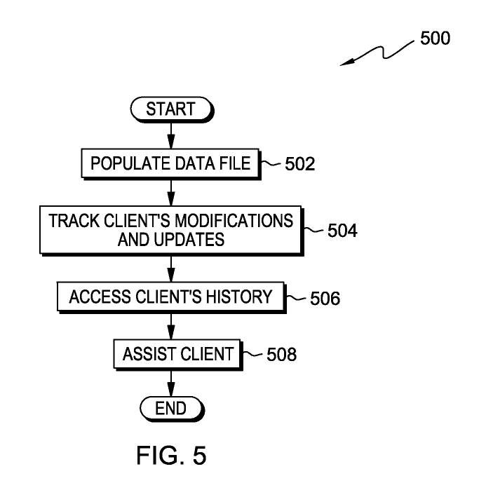

FIG. 5 depicts flowchart 500 of relevancy function 414, a function of service program 410, executing within the computing environment 400 of FIG. 2, in accordance with an embodiment of the present invention. Relevancy function 414 requests to collect information from user computing device 408 to identify the hardware and software setup. After the analysis has been complete relevancy function 414 sends the information to service provider computing device 406 to locate the appropriate customer service for the client.

In step 502, relevancy function 414 populates a data file with the parameters of user computing device 408 that relevancy function 414 needs to complete the task. In one embodiment, the data file is stored on database 412. In other embodiments, the data file is stored on another database as long as relevancy function 414 can access the data file. Relevancy function 414 accesses user computing device 408 and analysis the hardware and software setup of user computing device 408. Relevancy function 414 determines what hardware components, or software information is necessary. The hardware components relevancy function 414 may retrieve/determine can include motherboard, Random Access Memory (RAM), power supply, hard drives, Central Processing Units (CPU), video cards, or sound cards but is not limited to motherboard, Random Access Memory (RAM), power supply, hard drives, Central Processing Units (CPU), video cards, or sound cards. The software information that relevancy function 414 retrieves/determines can include make, model, version, applications, versions, operating systems, application functionality, and firmware versions but is not limited to make, model, version, applications, versions, operating systems, application functionality, and firmware versions. In other embodiments, relevancy function 414 accesses user computing device 408 and determine the software setup, including but not limited to operating system, programs, applications, firmware, and virtual hardware. Relevancy function 414 gathers the versions of each piece of software or firmware within user computing device 408 and stores the information in database 412. In other embodiments, relevancy function 414 prompts a client of user computing device 408 as to if it is acceptable to gather the information regarding user computing device 408. In some embodiments, relevancy function 414 automatically gathers the information.

In step 504, relevancy function 414 tracks the client's modifications and updates made to user computing device 408 which are accessible to service provider computing device 406 and updates the information in database 412. When the client or the users update the hardware, firmware, or software of user computing device 408, relevancy function 414 continuously monitors user computing device 408 and the user's computing devices. As user computing device 408 and the user's computing devices are modified, relevancy function modifies the client's information and each user's information within the data file to keep up to date records. In one embodiment, relevancy function 414 is informed when a modification is made to user computing device 408 or the user's computing devices. In one embodiment, each user has a file which is populated with information regarding their computing device, and the file is modified after the user modifies their computing device. In other embodiments, relevancy function 414 continuously monitors user computing device 408 and makes changes to the files to indicate any modifications or upgrades made to user computing device 408 only after the user has approved of the modifications.

In step 506, relevancy function 414 accesses client's history when a request is made by service provider computing device 406, and relevancy function 414 provides the client's history to service provider computing device 406. In one embodiment, service provider computing device 406 relays a request to service program 410, which uses relevancy function 414 to access database 412 and gather the necessary information to provide to service provider computing device 406. The information relevancy function 414 gathers is selected by the client who requested the customer service; depending on if the request was regarding hardware, firmware, and software of user computing device 408. In one embodiment, relevancy function 414 narrows down the search to specific hardware components or software versions if the requested customer service is inquiring about a specific set of hardware components or software versions. In other embodiments, relevancy function 414 is able to determine the amount of similarity between user computing device 408 and other computing devices. The amount of similarity can be, but is not limited to, percentage of similarity between hardware, firmware, and/or software similarities. In some embodiments, there is a required degree of similarity between user computing device 408 and the user's computing devices before relevancy function 414 determines the user's computing device is similar enough to user computing device 408 to be beneficial to the clients issue.

In step 508, relevancy function 414 assists the client by connecting users with similar setups to the client who made the service request. Relevancy function 414 can connect the client with one or more user. The client and the users communicate with each other until the client has solved the issues, then the communication is stored in database 412 for future reference when another client has a similar service request. In one embodiment, relevancy function 414 gives the client an option of how many users to connect with the client. In one embodiment, relevancy function communicates with a service provider to contact the users and request their approval to communicate with the client.

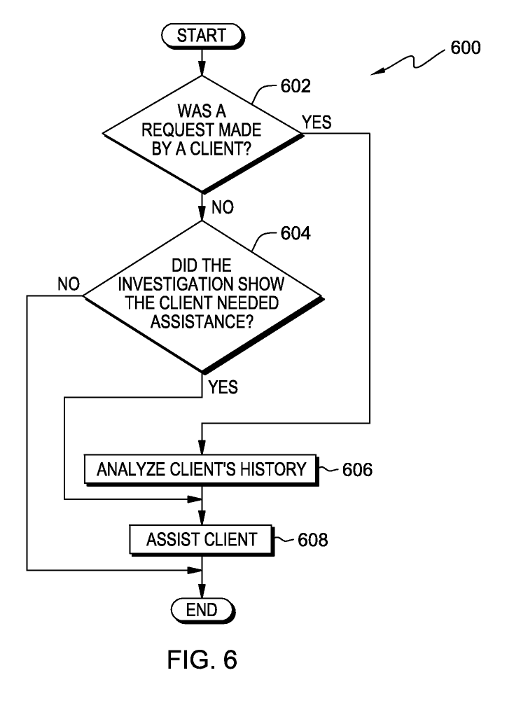

FIG. 6 depicts flowchart 600 of history function 416, a function of service program 410, executing within the computing environment 400 of FIG. 4, in accordance with an embodiment of the present invention. History function 416 performs an analysis of user computing device 408 to identify if there is any action which would require assistance or if it would assist a client if a formal request was made, after determining the actions the client made prior to the request. After the analysis has been completed, history function 114 sends the information to service provider computing device 406 to locate appropriate customer service for the client or history function 416 determines an action to perform from a request received by service provider computing device 406.

In decision 602, history function 416 determines if the client at user computing device 408 requests assistance. If no request was made but history function 416 determines the actions performed by the client implicitly show the client needs assistance, history function 416 investigates the client's actions and will investigate to see if the client does need assistance (No branch, proceed to decision 604). If history function 416 determines that a request is made, history function 416 analyzes the client's actions (Yes branch, proceed to step 606).

In decision 604, history function 416 implicitly determines if the client is in need of assistance. If history function 416 determines that client does not need assistance, history function 416 ends the operation (No branch, proceed to END). If history function 416 determines that client implicitly requires assistance history function 416 will determine the best service method (Yes branch, proceed to step 608). History function 416 can determine that client implicitly requires assistance by the actions taken by the client. An example of some of the actions the client could perform are the client repeatedly performing the same step, taking much longer than what is expected for a given task, or performing generalized web searches on help topics related to an application but not limited to the client repeatedly performing the same step, taking much longer than what is expected for a given task, or performing generalized web searches on help topics related to an application.

In step 606, history function 416 analyzes the client's history to determine what issue the client is experiencing. History function 416 accesses user computing device 408 and analyzes the computing device's history. This analysis for example can be searching for hardware updates, software updates, firmware updates, client actions, client past requests, but are not limited to just searching for hardware updates, software updates, firmware updates, client actions, client past requests. In one embodiment, history function 416 analyzes the client's history and stores this information on database 412.

In step 608, history function 416 assists the client by determining the service method for the client based of the history search results. History function 416 determines if client should receive assistance in a group or peer to peer style customer service experience. In some embodiments, history function 416 customer service assistance needs to be approved by the client, before the client and the users can communicate with each other. In other embodiments, history function 416 sends the client tutorials, webinars, or other forms of textual, images, or videos assistance to the client. The client and the users communicate with each other until the client has solved the issues, then the communication is stored in database 412 for future reference when another client has a similar service request. In one embodiment, history function 416 gives the client an option of how many users to connect with the client. In one embodiment, history function 416 communicates with a service provider to contact the users and request their approval to communicate with the client.

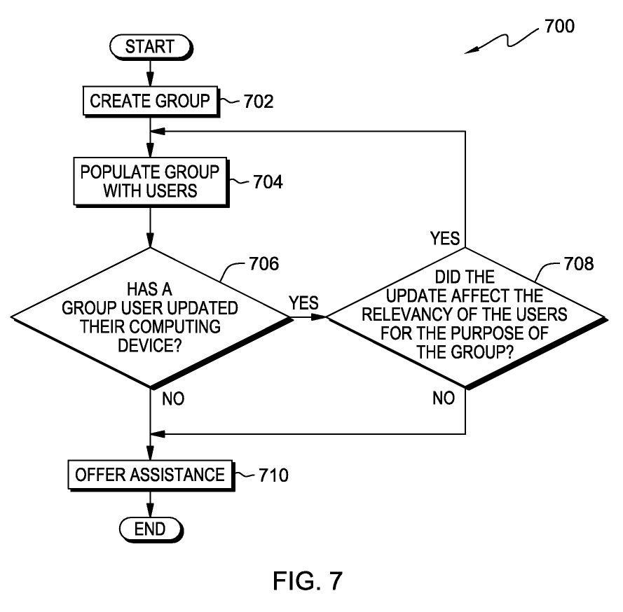

FIG. 7 depicts flowchart 700 of similarity function 418, a function of service program 410, executing within the computing environment 400 of FIG. 4, in accordance with an embodiment of the present invention. Similarity function 418 creates a group for the client when a service request is made. Similarity function 418 gathers users of similar hardware, firmware, or software and creates a group of the gathered users. The information is used to populate the group with participants.

In step 702, similarity function 418 creates a group for the client who requested the support of other users or automatically identified as in need for support by history function 416. In one embodiment, similarity function 418 compiles a list of other user computing devices and determines which users have environmental parameters which are similar to the client. The environmental parameters for example can be hardware, software, or firmware. Similarity function 418 determines which environmental parameters are relevant, this selection is completed for example by analyzing the client's request, a predefined setting of service program 404, or predefined parameters set out by the service provider.

In step 704, similarity function 418 populates the group with users that have met the environmental parameters. In one embodiment, similarity function 418 prompts each user if they would join the group. In one embodiment, similarity function 418 automatically adds each user selected by to the group. In one embodiment, similarity function 418 has a maximum number of users that are allowed to be added to the group, that once that number of users is met, similarity function 418 stops adding members to the group. In one embodiment, similarity function 418 has a minimum number of users to add to the group, if similarity function 418 does not find enough users that met the environmental parameters, similarity function 418 will expand the environmental parameters to meet the minimum number of users required for the group.

In decision 706, similarity function 418 determines if a group user has updated their computing device. Similarity function 418 periodically monitors the user's computing devices that are members of the group as well as user computing device 408. Similarity function 418 monitors the hardware, software, or firmware of the user computing devices associated with members of the group, and user computing device 408. In one embodiment, similarity function 418 installs software on the user computing devices that are members of the group and when an update or modification to the user computing devices is noticed by the software, the software will communicate this update or modification to similarity function 418. If similarity function 418 determines that a user computing device associated with a member of the group is updated (Yes branch, proceed to decision 706). If similarity function 418 determines that no changes have been made to user computing devices associated with members of the group, similarity function 418 offers assistance to the client (No branch, proceed to step 710).

In decision 708, similarity function 418 determines if the update to the users computing device renders the user computing device and/or the associated user affects the relevancy of users for the group. In one embodiment, similarity function 418 compares user computing device 408 parameters, and those of the user computing devices in the group. If similarity function determines that a user computing device does not meet the minimum environmental parameters, similarity function 418 removes the user or users that do not meet the minimum environmental parameters and repopulate the group (Yes branch, proceed to step 704). If similarity function 708 determines that the user computing devices that were updated or modified does not affect the minimum environmental parameters, similarity function 418 offers the client assistance (No branch, proceed to step 710). In one embodiment, after similarity function 418 removes a user from the group they were in, similarity function 418 may prompt, or otherwise query the user, as to if they want to join another group, if an applicable group exists, that corresponds to the user's current computing device setup.

In step 710, similarity function 418 offers assistance to the client by creating the group and permitting the members of the group to assist the client in solving the issue. The client and the users communicate with each other until the client has solved the issues, then the communication is stored in database 412 for future reference when another client has a similar service request. In one embodiment, similarity function 418 gives the client an option of how many users to connect with the client.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

In another embodiment, the invention provides a method that performs the process of the invention on a subscription, advertising, and/or fee basis. That is, a service provider, such as a Solution Integrator, could offer to provide a process to use stored data of users computing devices to direct the users to a more efficient and effective customer service functionality. In this case, the service provider can create, maintain, support, etc., a computer infrastructure, such as cloud computing environment 200 (FIG. 4) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for providing a process to use stored data of users computing devices to direct the users to a more efficient and effective customer service. In this case, a computer infrastructure, such as cloud computing environment 200 (FIG. 4) can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as cloud computing environment 200 (FIG. 4), from a computer readable medium; (2) adding one or more computing devices to the computer infrastructure; and (3) incorporating and/or modifying one or more existing systems of the computer infrastructure to enable the computer infrastructure to perform the processes of the invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device which can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

the computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. the computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for assisting a user with a service request, the method comprising:
determining, by one or more processors, that an error has occurred on a first computing device of a first user;
identifying, by one or more processors, information about the first computing device;
determining, by one or more processors, that the first computing device corresponds to a group of one or more additional computing devices, within a predetermined threshold, based on at least, on the information about the first computing device; and
causing, by one or more processors, the first user to enter into a communication with at least a second user of a second computing device, wherein the second computing device is one of the group of one or more additional computing devices.

2. The method of claim 1, wherein the additional computing devices of the group of one or more additional computing devices include matching software and hardware configurations, within the predetermined threshold.

3. The method of claim 1, further comprising:
receiving, by one or more processors, an indication of a change to information about a third computing device of the group of one or more additional computing devices;
determining, by one or more processors, that the third computing device does not correspond to the group of one or more additional computing devices, within the predetermined threshold, based on the changed information about the third computing device; and
removing, by one or more processors, the third computing device from the group of one or more additional computing devices.

4. The method of claim 1, further comprising:
adding, by one or more processors, the first computing device to the group of one or more additional computing devices.

5. The method of claim 1, wherein determining that the error has occurred on the first computing device comprises:
monitoring, by one or more processors, actions occurring on the first computing device; and
determining, by one or more processors, that the error has occurred on the first computing device based on the monitored actions.

6. The method of claim 5, wherein the monitored actions comprise repeated unsuccessful attempts to perform a single task.

7. The method of claim 1, wherein determining that the error has occurred on the first computing device comprises:
receiving, by one or more processors, an indication that the error has occurred on the first computing device.

8. A computer program product for assisting a user with a service request, the computer program product comprising:
one or more computer readable storage media and program instructions stored on the one or more computer readable storage media, the program instructions comprising:
program instructions to determine that an error has occurred on a first computing device of a first user;
program instructions to identify information about the first computing device;
program instructions to determine that the first computing device corresponds to a group of one or more additional computing devices, within a predetermined threshold, based on at least, on the information about the first computing device; and
program instructions to cause the first user to enter into a communication with at least a second user of a second computing device, wherein the second computing device is one of the group of one or more additional computing devices.

9. The computer program of claim 8, wherein the additional computing devices of the group of one or more additional computing devices include matching software and hardware configurations, within the predetermined threshold.

10. The computer program of claim 8, further comprising:
program instructions, stored on the one or more computer readable storage media, to receive an indication of a change to information about a third computing device of the group of one or more additional computing devices;
program instructions, stored on the one or more computer readable storage media, to determine that the third computing device does not correspond to the group of one or more additional computing devices, within the predetermined threshold, based on the changed information about the third computing device; and
program instructions, stored on the one or more computer readable storage media, to remove the third computing device from the group of one or more additional computing devices.

11. The computer program of claim 8, further comprising:
program instructions, stored on the one or more computer readable storage media, to add the first computing device to the group of one or more additional computing devices.

12. The computer program of claim 8, wherein program instructions to determine that the error has occurred on the first computing device comprise:
program instructions to monitor actions occurring on the first computing device; and
program instructions to determine that the error has occurred on the first computing device based on the monitored actions.

13. The computer program of claim 12, wherein the monitored actions comprise repeated unsuccessful attempts to perform a single task.

14. The computer program of claim 8, wherein program instructions to determine that the error has occurred on the first computing device comprise:
program instructions to receive an indication that the error has occurred on the first computing device.

15. A computer system for maintaining assisting a user with a service request, the computer system comprising:
one or more computer processors, one or more computer readable storage media, and program instructions stored on the one or more computer readable storage media for execution by at least one of the one or more processors, the computer instructions comprising:
program instructions to determine that an error has occurred on a first computing device of a first user;
program instructions to identify information about the first computing device;
program instructions to determine that the first computing device corresponds to a group of one or more additional computing devices, within a predetermined threshold, based on at least, on the information about the first computing device; and
program instructions to cause the first user to enter into a communication with at least a second user of a second computing device, wherein the second computing device is one of the group of one or more additional computing devices.

16. The computer program of claim 15, wherein the additional computing devices of the group of one or more additional computing devices include matching software and hardware configurations, within the predetermined threshold.

17. The computer program of claim 15, further comprising:
program instructions, stored on the one or more computer readable storage media for execution by at least one of the one or more processors, to receive an indication of a change to information about a third computing device of the group of one or more additional computing devices;
program instructions, stored on the one or more computer readable storage media for execution by at least one of the one or more processors, to determine that the third computing device does not correspond to the group of one or more additional computing devices, within the predetermined threshold, based on the changed information about the third computing device; and
program instructions, stored on the one or more computer readable storage media for execution by at least one of the one or more processors, to remove the third computing device from the group of one or more additional computing devices.

18. The computer program of claim 15, further comprising:
program instructions, stored on the one or more computer readable storage media for execution by at least one of the one or more processors, to add the first computing device to the group of one or more additional computing devices.

19. The computer program of claim 15, wherein program instructions to determine that the error has occurred on the first computing device comprise:
program instructions to monitor actions occurring on the first computing device; and
program instructions to determine that the error has occurred on the first computing device based on the monitored actions.

20. The computer program of claim 15, wherein program instructions to determine that the error has occurred on the first computing device comprise:
program instructions to receive an indication that the error has occurred on the first computing device.
